(19) United States
(12) Patent Application Publication
(10) Pub. No.: US 2009/0072029 A1
(43) Pub. Date: Mar. 19, 2009

(54) INVENTORY CONTROL SYSTEM

(75) Inventor: William Wesley Martin, Milton Keynes (GB)

Correspondence Address: KNOBBE MARTENS OLSON & BEAR LLP, 2040 MAIN STREET, FOURTEENTH FLOOR, IRVINE, CA, 92614, US

(73) Assignee: Zeroshift Limited, Milton Keynes (GB)

(21) Appl. No.: 12/192,910

(22) Filed: Aug. 15, 2008

(30) Foreign Application Priority Data
Aug. 17, 2007 (GB) 0716085.6

(51) Int. Cl. G06F 19/00

(52) U.S. Cl. 235/385

(57) ABSTRACT

An inventory control system is disclosed. The system includes a plurality of inventory item storage locations, an access system for controlling access to the inventory items, where the access system includes an input device for entering the identity of a user, a monitoring system for monitoring the removal and replacement of the inventory items from the storage locations, at least one locatable device that is arranged to be carried by a user of the inventory control system and that is locatable by a positioning system, a positioning system, arranged to determine the location of the locatable device, and a data processing system for recording the removal and replacement of inventory items and location data received from the positioning system such that the movement of the or each locatable device can be tracked.

### CROSS REFERENCE TO RELATED APPLICATIONS

This Application claims priority to British Application No. GB0716085.6, filed Aug. 17, 2007, the specification of which is incorporated herein by reference.

### BACKGROUND

1. Field

The field relates to an inventory control system and in particular, but not exclusively, to an inventory control system for monitoring the use of hand tools surgical instruments or other items. The field also relates to an inventory control process.

2. Description of the Related Technology

An inventory control system may be useful when it is important to monitor the usage of items, and to ensure that they are returned to storage after use. This can help to ensure that items are not lost or stolen. Such a system is particularly important when tools are used for repairing or maintaining aircraft engines, as any tools left inside the engine after completion of the job could cause catastrophic damage. Similarly. in the case of surgical tools, it is essential to ensure that no tools are left inside a patient after an operation.

An inventory control system can also be useful by helping to ensure that only the correct tools are used for a particular task. Such a system may also be helpful to track the identity of the person using the tools, so that if a tool goes missing or if a tool is taken that is inappropriate for the task in hand, appropriate remedial action can be taken.

One method of monitoring the use of tools is to apply an RFID tag to each tool and provide an RFID tag reader in a storage container to monitor the removal and replacement of tools from the container. However a major drawback to this type of technology is that the RFID tags can easily become dissociated from the tools, for example by rough handling or because the adhesive used to apply the tags to the tools does not form a satisfactory bond with the tool. Furthermore some tools are not suitable to be tagged because of their size/shape/material and/or the processes that they are used in.

Another inventory control system is disclosed in WO 2005/028165. That system uses a set of sensors to monitor the removal and replacement of tools according to the signals received from the sensors.

Although the RFID type system and the system disclosed in WO 2005/028165 can provide a supervisor with tool status information, neither system is capable of assisting the supervisor, or a user of the system, to locate missing tools. This is a serious problem in some industries, for example in aircraft manufacture or maintenance, since tools left in vulnerable parts of an aircraft can lead to catastrophic damage. Accordingly, when a tool is identified as missing, the production process may have to be temporarily halted, or the aircraft grounded, while efforts are made to locate the missing tool. This has a significant time and cost implication for manufacturers and for aircraft owners.

### SUMMARY OF CERTAIN INVENTIVE APSPECTS

Accordingly, certain embodiments seek to provide an inventory control system and process that mitigates at least some of the aforesaid problems, or to at least provide an alternative to known systems and processes.

According to one aspect, there is provided an inventory control system including a plurality of inventory item storage locations, an access system for controlling access to the inventory items, said access system including an input device for entering the identity of a user, a monitoring system for monitoring the removal and replacement of the inventory items from the storage locations, at least one locatable device that is arranged to be carried by a user of the inventory control system and that is locatable by a positioning system, a positioning system arranged to determine the location of the or each locatable device, and a data processing system for recording the removal and replacement of inventory items, the identity of the user of the inventory items and location data received from the positioning system such that the movement of the or each locatable device can be tracked.

Certain embodiments enable the inventory control system to determine, which inventory items a user has removed from the storage locations and to track the movements of the user while he is in possession of the inventory items such that, if a tool is lost, it is possible to retrace the steps of the user from the tracking information recorded to increase the likelihood of the tool being retrieved. This system has particular application to the aerospace industry where lost tools can cause significant damage to aircraft, for example when tools are left in jet engines during routine maintenance. By tracking the movement of the user of the tool this allows the user to retrace his/her steps in order to improve the chances of the tool being found and significantly reducing the amount of time spent looking for the tool. In some instances it may also prevent aircraft from being grounded, which may happen if it is feared that the tool was lost in a vulnerable part of the aircraft.

Furthermore, since the locatable device is not attached to the inventory item but rather is carried by the user, the problem of tags becoming disassociated from inventory items, particularly tools in engineering industries, is overcome. Also, significantly fewer locatable devices are required than if every inventory item were to be tagged which can lead to a cost saving.

Advantageously, the positioning system can comprises a real time location system and the position of the locatable device can be determined by a known technique such as triangulation or trilateration. The positioning system can comprise a base station system that includes a plurality of transmitter-receiver devices distributed about the area to be covered. In a preferred embodiment the locatable device includes an RFID tag and the positioning system includes a plurality of RFID tag detecting devices arranged to locate the locatable device by, for example triangulation. Alternatively, the locatable device can include a RuBee tag and the positioning system includes a plurality of RuBee tag detecting devices, arranged to locate the locatable device by, for example triangulation. Other known locating techniques such as time of flight and synchronisation techniques can be used.

Alternatively, the locatable device can be a GPS type device and the means for tracking the movement of the trackable device can be a suitable GPS tracking system. This is particularly useful for outdoor applications requiring a large area of coverage.

Advantageously, the monitoring system can include a sensor system. For example, the sensor system can include a plurality of sensors for sensing the presence of inventory items in the storage locations, each sensor being associated with one of the storage locations and arranged to generate a signal representing the presence or absence of the inventory item.

Advantageously, each inventory item storage location may comprises an individually-shaped recess for receiving a specific inventory item, the shape of the recess being matched to the shape of the inventory item. Preferably the monitoring system is arranged such that each sensor is located in or adjacent the recesses and is arranged to detect the inventory item located therein. At least some of the sensors may consist for example of optical sensors or magnetic sensors for sensing the presence of ferromagnetic materials. Such sensors have the advantage of being cheap, robust and simple. The combination of the recesses and associated sensor devices has been found to be a particularly effective form of inventory control.

The monitoring system monitors which tools have been removed from and replaced in the container, and indicates the presence and/or absence of the tools. This makes it easy to assess whether all the tools taken from the container have been returned after use, thus reducing the risk of any tools being inadvertently left behind. Safety in situations such as aircraft engine maintenance is thus significantly improved. Some embodiments also reduce the risk of tools being lost or stolen, since the fact that a tool has gone missing can be indicated immediately. The system also makes it possible to monitor which tools are being taken for any specified task, thereby helping to ensure best practice in maintenance operations.

The individually-shaped recesses for receiving the tools ensure that tools are always returned to the correct storage locations. This makes it possible for the system to identify which tools have been removed, without requiring the use of sophisticated sensors and tagging devices on the tools. It also allows a visual check of the tools to be completed very easily, by looking for any empty recesses. This provides a manual backup to the automatic system, allowing the full complement of tools to be confirmed easily, even in the event of a power failure or other fault. Preferably, the recesses are colour-coded, to simplify further the visual checking process.

The data processing system can be constructed and arranged to identify the inventory items located in the storage locations from the signals received from the monitoring system. For example, the monitoring system can include a camera system and image recognition means for identifying the inventory items by their shape; a camera system with optical character recognition means for reading codes etched onto, or otherwise attached, to the inventory items; or barcode reading devices for reading barcodes applied to the inventory items.

The inventory control system can include an enclosure, such as a container for storing tools, having a closure member that can be opened and closed by a user in order to gain access to the enclosure. Preferably the container includes a plurality of storage compartments.

Advantageously, the access control system includes a locking system for controlling access to the inventory items. The access control system includes at least one user identification device to enable a user to login into the access system via the input device. The or each user identification device may comprise: a swipe card, a chip and pin card, an RFID tag, a RuBee tag and a proximity device. The input device comprises a compatible reading device. Advantageously the locking mechanism can be arranged to automatically open when an authorizauthorized user has been identified.

Advantageously, the locatable device and the identification device can be integrated into a single unit. For example, a swipe card used for identification purposes can be adapted to include a locatable device such as a RuBee or RFID tag. Alternatively, the same RuBee or RFID tag can be used as identification means and as the locatable device.

The system may include storage locations for receiving the or each locatable device. This enables the locatable devices to be stored in the inventory item enclosure and to be removed for tracking purposes when taking inventory items. Advantageously the monitoring system is arranged to monitor the removal and replacement of the or each locatable device to check whether or not one of the locatable devices has been removed from its storage location when an inventory item has been removed. If not, an alert is issued to the user, for example by pager or cell phone, to instruct him/her to take a locatable device. Alternatively the alert can be provided to a supervisor, for example as a pop up message on a computer display screen, and the supervisor can instruct the user to take a locatable device.

The data processing system can be arranged to start tracking the movement of the locatable device in response to receiving signals from the monitoring system indicating that at least one of the locatable devices has been removed from its storage location. The data processing system can be arranged to stop tracking the movement of the locatable device in response to receiving signals from the monitoring system indicating that the locatable device has been returned to its storage location. Thus the privacy of the user is respected since his/her movements are only tracked when he/she has removed tools from the tool cabinet. When the tools and locatable devices are replaced the tracking action ceases.

The data processing system is arranged to receive signals from the access system and can be arranged to start tracking the movement of the locatable device in response to receiving signals from the access system indicating that the user has logged in and/or the user has removed inventory items from the storage locations. The data processing system can be arranged to stop tracking the movement of the user carried locatable device in response to receiving signals from the monitoring system indicating that the user has replaced the inventory items in the storage locations. This provides the user with some privacy. That is, the user's movements are not tracked when he is not using the inventory control system. Alternatively, the tracking process can be terminated when user logs out from the access system.

The system can include means for determining the operational status of the locking mechanism and means for inhibiting the operation of the monitoring system according to the signals received from the means for determining the operational status of the locking mechanism.

The data processing system is arranged to record the time of removal and replacement of inventory items. It can also record the time that a user logs on/off and when a tracking process has started and stopped. The data processing system can be located remotely from the enclosure and is connected thereto by a data link.

In some embodiments, the enclosure includes a local indicator device for indicating the presence and/or absence of inventory items in the enclosure.

According to another aspect, there is an inventory control process including providing a plurality of inventory item storage locations, an access system for controlling access to the inventory items, said access system including an input device for entering the identity of a user, a monitoring system for monitoring the removal and replacement of the inventory items from the storage locations, at least one locatable device that is arranged to be carried by a user of the inventory control system and that is locatable by a positioning system, a positioning system arranged to determine the location of the or each locatable device, and a data processing system for recording the removal and replacement of inventory items, the identity of the user of the inventory items and location data received from the positioning system such that the movement of the or each locatable device can be tracked.

The inventory control process can use an inventory control system according to any of the configurations described herein.

The process may include starting tracking the movement of the locatable device in response to receiving signals from the access system indicating that the user has logged in and/or the user has removed inventory items from the storage locations.

The process may include stopping tracking the movement of the locatable device in response to receiving signals from the monitoring system indicating that the user has replaced the inventory items in the storage locations. Alternatively, the tracking process can be terminated when user logs out from the access system.

The process may include providing storage locations for the or each locatable device, monitoring the removal and replacement of the or each locatable device from the storage locations and starting tracking the movement of the locatable device in response to receiving signals from the monitoring system that the locatable device has been removed from its storage location. The process may include stopping tracking the movement of the locatable device in response to receiving signals from the monitoring system indicating that the locatable device has been returned to its storage location.

According to another aspect, there is a method of locating a lost tool, said method including the user logging on to an access control system, removing the tool from a storage location, detecting the removal of the tool from the storage location with a monitoring system, recording an association between the user and the tool according to the signals received from the monitoring system and the access control system, the user of the tool carrying a trackable device that is locatable by a positioning system and that is separate from the tool, using a positioning system to track the movement of the user while the tool is associated with the user, recording the movement of the user by recording the movement of the tracking device and reviewing the record of the user's movement in the event that the tool becomes lost.

Advantageously the method may include monitoring the removal and replacement of tools or other items in a container having a plurality of tool storage locations, each tool storage location comprising an individually-shaped recess for receiving a specific tool, the shape of the recess being matched to the shape of the tool, and sensing means including a plurality of sensors for sensing the presence of tools in the tool storage locations, each sensor being located adjacent a recess for sensing the presence of a tool in the recess, the process including sensing the presence of tools in a plurality of tool storage locations in the container, monitoring signals from the sensing means, recording the removal and replacement of tools, and indicating the presence and/or absence of tools in the container.

According to yet another aspect, the tools can be magnetised prior to use and may be located by carrying a magnetic field sensor along the traced path of the user.

### BRIEF DESCRIPTION OF THE DRAWINGS

Various aspects will now be described, by way of example, with reference to the accompanying drawings, in which:

FIG. 1 is an isometric view of a tool cabinet with an open tool drawer;

FIG. 2a is a perspective view from above of the drawer shown in FIG. 1;

FIG. 2b is a perspective view of the tool cabinet from the rear;

FIG. 3 is a plan view showing the layout of another tool drawer;

FIG. 4 is a view from below, showing the layout of tool sensors in the drawer shown in FIG. 3;

FIG. 5 is an enlarged isometric view of a swipe card reader, keypad and LED indicator panel;

FIG. 6 is a schematic diagram illustrating the main components of an inventory control system; and

FIG. 7 is a flow diagram showing the main steps of an inventory control process.

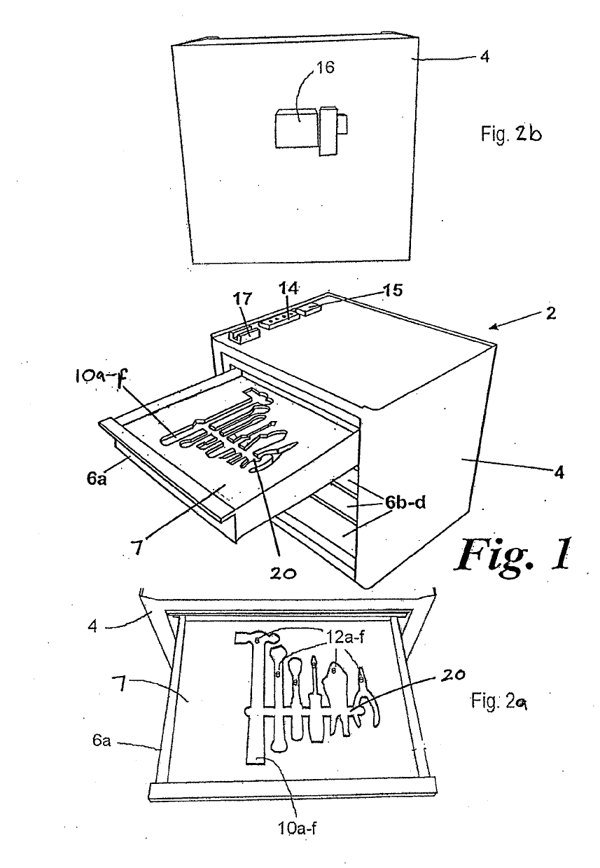

### DETAILED DESCRIPTION OF CERTAIN INVENTIVE EMBODIMENTS

The tool cabinet 2 shown in the Figures includes a steel cabinet housing 4, which may be static or mobile (for example, it may be mounted on castors), four tool drawers 6a-6d, the top drawer 6a being shown pulled out in FIG. 1, four micro-switches 8a-d, sensors 12, a computer processing device 13, a local display 14, a data transmission unit 16, a power supply unit 18, and a backup electrical supply in the form of a rechargeable cell 20.

Each drawer includes a liner 7, for example of a rigid foam material, having a number of cut-out compartments (or recesses) 10a-10f, which are shaped to receive specific tools. The recesses are preferably colour-coded, to provide a simple visual indication that a tool has been removed. For example, the recesses may have a bright colour (e.g. yellow), while the top surface of the drawer liner has a contrasting colour (e.g. black). The liner 7 also includes at least one additional recess 20 that provides a finger hole to enable a user to more easily remove tools from the recesses 9a-f. FIG. 4 shows an alternative layout of recesses 9.

Each of the micro-switches 8a-d is connected to the computer device 13. Each micro-switch 8a-d is associated with one of the four drawers 6a-6d and is arranged to be activated when its associated drawer is closed. Thus from the signals received from the micro-switches 8a-d, the computer device 13 knows when the tool cabinet 2 is open, when it is closed, and which drawer 6a-d has been opened.

Within or adjacent to each compartment 10, one of the sensors 12a-12f is provided, which senses the presence in the compartment of a tool. The sensors may for example be Hall effect sensors, to detect the ferromagnetic materials such as iron or steel, from which most tools are made. Alternatively, other types of sensor can be used, including for example optical sensors, mechanical contact switches and so on.

The sensors 12 are connected to the computer device 13, which is arranged to receive signals from the sensors 12. The local display 14 is connected to the computer 13 and is arranged to provide visual indications to users of the system. The data transmission system 16 enables the computer 13 to communicate with a remote computer system 26 having database software for maintaining an inventory of the tools in the cabinet. Preferably the data transmission system 16 is a wireless system such as an infrared, radio or GSM link. Alternatively, the computer 13 can be connected to the computer system 26 via a physical link 16 such as a USB cable or fibre optic cable (not shown). The computer system 26 may be kept at the same site as the cabinet 2 or at a remote location.

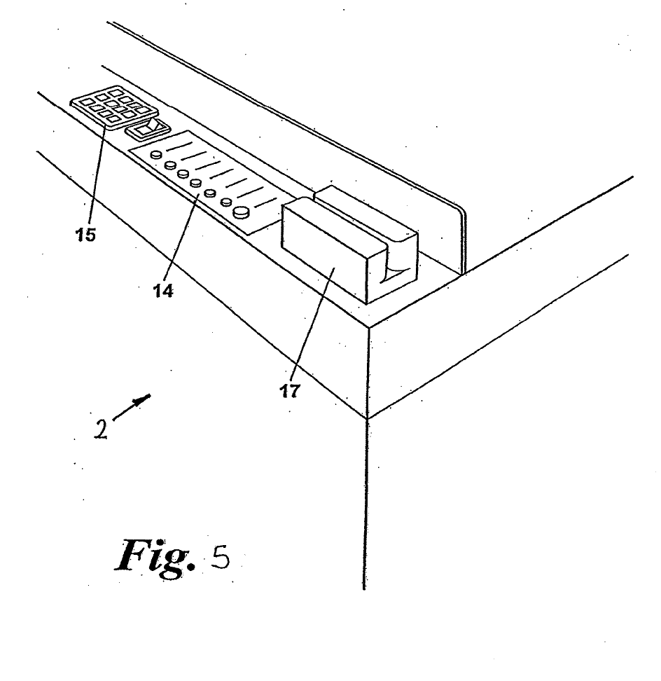

The tool cabinet 2 also includes an access system that includes an electrically operated lock 30 for the drawers, which can be actuated by the user identifying him/herself by presenting an identification token 29 to a suitable reading device 17. For example, the access system can include a swipe card reader 17 and each user is issued with a suitable swipe card that includes an identification code associated with the user (see FIG. 5). Alternatively, the access system can include a keypad 15 and PIN identification, a chip and PIN card and reader system, proximity tags and sensor system, a RuBee tag and reader or an RFID tag and reader. This allows the identity of the user to be monitored. The data can be stored in a database of tool usage.

The identification token 29 also includes an RFID tag 31. The RFID tag 31 can be a passive, semi-passive or an active tag 31, the choice depends on the application, which includes a consideration of the environment and the detection range required.

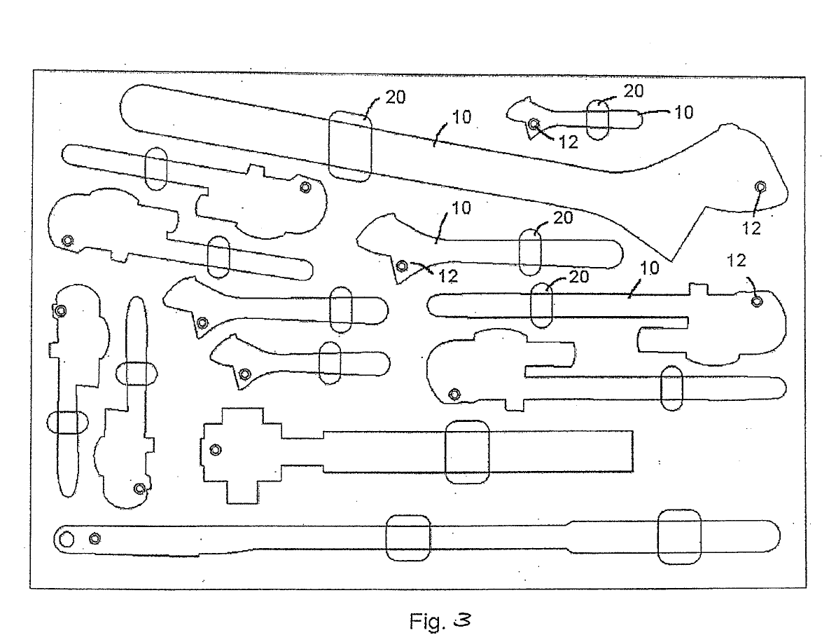

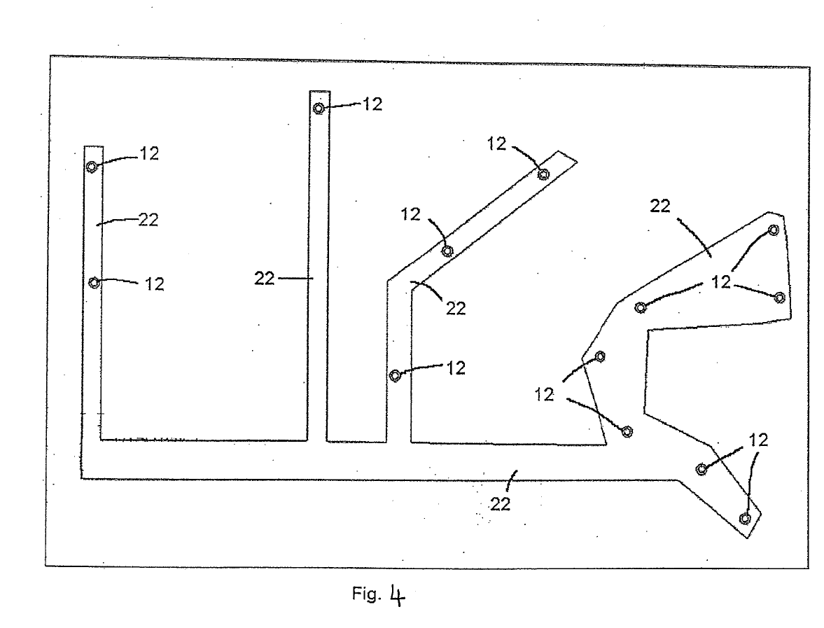

FIG. 3 shows an alternative drawer layout, with a number of tool compartments 10 and sensors 12. Each of the compartments also includes a finger recess 20, allowing the tool to be easily removed from or replaced in the appropriate recess 10. The sensors 12 are interconnected by means of a printed circuit 22, as shown in FIG. 4.

The input pad 15 can be used to input other data, such as a part number or to select options on a menu system.

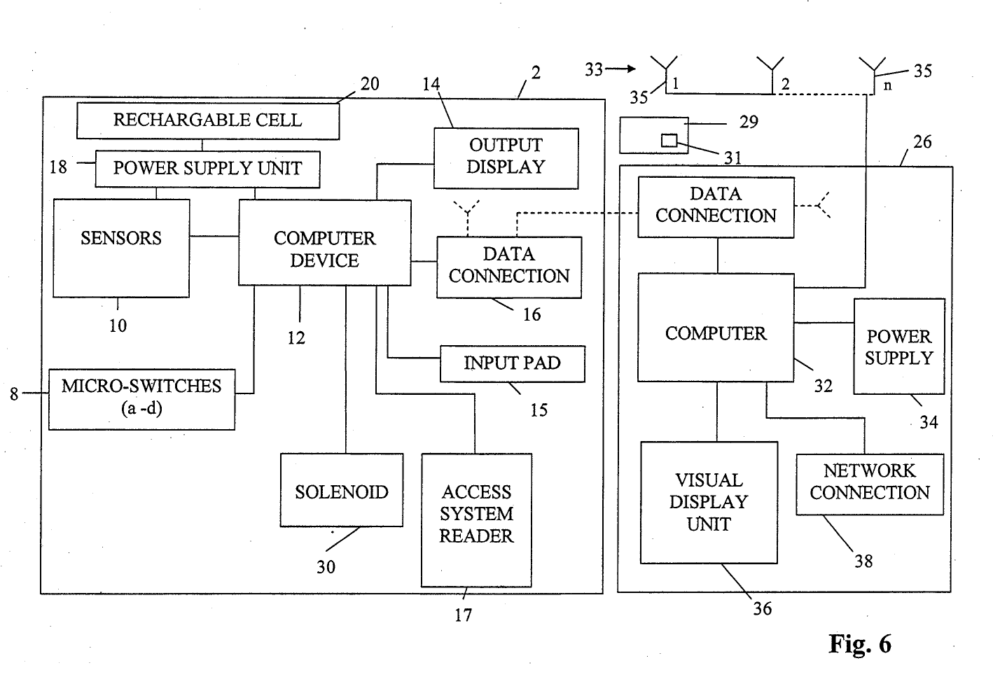

The main components of an inventory control system, are shown schematically in FIG. 6. The system includes the tool cabinet 2 described above, the remote computer system 26, which is connected to the cabinet 2 via the data transmission unit 16, and an RFID positioning system 33 that is arranged to detect the position of the RFID tag 31. The computer system 26 includes a central processing unit 32, a power supply 34 and a visual display unit 36 and optionally a network connection 38. The computer system 26 includes a database of all the tools stored in the cabinet 2.

The RFID positioning system 33 includes at least three RFID base stations 35 that are used to locate the RFID tag 31 by triangulation. The base stations 35 are distributed around the facility to provide the desired coverage. If necessary, more than three base stations 35 can be used to either improve accuracy or to provide greater coverage. The computer system 26 is connected to each base station 35, either by a physical link or wireless link, and is arranged to determine the position of the RFID tag 31 according to the signals received from the base stations. The computer system 26 is arranged to record the position data over time and there by create a record of the movement of the user of the system.

The computer system 26 can be arranged to commence tracking movement of the movement of the RFID tag 31 immediately after the user has logged in, after the user has logged in and after having removed at least one of the tools from the its recess 10, or having logged in, removed at least one tool and having logged out again. Similarly, the computer system 26 can be arranged to cease tracking the movement of the RFID tag 31 when all the tools removed by the user have been replaced in their recesses, or when all the tools removed by the user have been replaced in their recesses and the user has logged out. Automatic starting and stopping of the tracking process is desirable to ensure that there is a complete record of the user's movements when he has tools in his possession while on the other hand stopping tracking when the work is complete to protect the user's privacy. Thus in the event of a tool being lost the user, or a supervisor, can retrace the user's steps thereby increasing the probability of the tool being found. Since the RFID tag 31 is attached to the identification token 29 it is not subject to the rough handling that the tools are and therefore is less likely to be damaged and become disassociated from the identification token 29.

If three base stations 35 are used triangulation can be achieved in two dimensions. If four base stations 35 are used triangulation can be achieved in three dimensions. The number of base stations 35 and their relative positions will be dependent on the specific application.

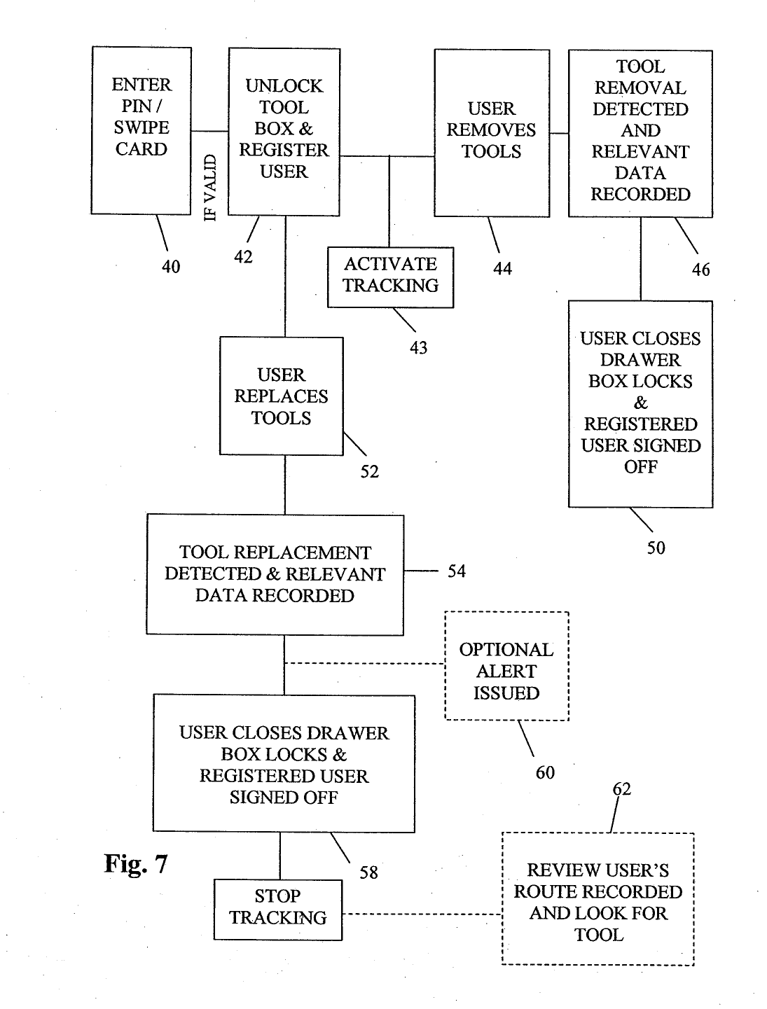

An inventory control process carried out using the system described above will now be described with reference to FIG. 7, which shows the steps of a typical control process. First, a user (for example a technician or mechanic) identifies him or herself 40 by using the identification token 29. The identity of the user is checked against a list of authorizauthorized users held on the computer system 26 and, if the authorizauthorization of the user is valid, the lock 30 of the tool box is unlocked, allowing the user to gain access to the tools. At the same time, the identity of the user and the time are recorded 42 in a database on the computer. If the identity of the user is not validated as that of an authorizauthorized user, the tool box remains locked, preventing access to the tools. Optionally, a warning may be generated, to indicate that an unauthorized person has attempted to gain access.

When the identity of the user has been validated, the RFID tracking system is activated 43 and begins to track and record the position of the user via the RFID tag that the user carries. The user then removes the required tools from the cabinet and the sensors automatically detect 44 which tools have been removed. This information is transmitted to the computer system 26, where it is recorded 46, together with the time of removal.

The user then closes the cabinet and, after a short delay, the box then re-locks automatically 50, and the registered user is signed off.

As the user moves from the cabinet to the place where the task is to be undertaken, the RFID positioning system 33 continuously monitors the position of the user and the computer system 26 records his/her location.

If the tool should become lost, the user is able to access the record of his/her movements 62 in order to determine the most likely position of the lost tool.

When the tool has been found, the user re-enters his or her ID 40, and once this has been verified the box unlocks 42 and the identity of the user is registered on the computer. The user then replaces the tools 52 in the appropriate recesses 10: this is sensed by the sensors 12 and the identity of the tools that have been replaced is recorded on the computer 54, together with the time of replacement. The user then again closes the cabinet and, after a short delay, the box re-locks and the user is logged off 58. At this time. the computer system 26 stops recording position data received from the positioning system 33.

The computer system 26 records which tools are in use, who has taken them and the time at which the tools are removed and returned. Using this information, it is a simple matter for a supervisor to check whether all the tools are present in the cabinet and, if any are missing, who has taken them and when. The supervisor can also check that the tools taken for a particular task are appropriate for that task. Checks can be carried out by the supervisor whenever required, or they can be instigated automatically, for example whenever the cabinet is opened or at predetermined intervals. In addition, the tool cabinet can be checked visually at regular intervals, to ensure that the full complement of tools is present and that the automatic system is operating correctly.

The computer 26 can also keep a continuous log of how long each tool has been in use, which may be useful for tools and measuring instruments such as torque wrenches that have to be recalibrated at preset intervals. It can also be programmed to disregard the absence of tools that have been removed deliberately for repair or replacement.

The computer 26 therefore records which tools are in use, who has taken them and the time at which the tools are removed and returned. Using this information it is a simple matter for a supervisor to check whether all the tools are present in the cabinet and, if any are missing, who has taken them and when. The supervisor can also check that the tools taken for a particular task are appropriate for that task. Checks can be carried out by the supervisor whenever required or they can be instigated automatically, for example whenever the cabinet is closed. In addition the tool cabinet can be checked visually at regular intervals, to ensure the full complement of tools is present and that the automatic system is operating correctly. The computer 26 can also keep a continuous log of how long each tool has been in use, which may be useful for tools and measuring instruments such as torque wrenches that have to be recalibrated at preset intervals. The supervisor can also use the information as part of a schedule management system, which assigns an amount of time to a particular task. If the tool is not returned within a certain period an alert can be issued. This can provide an early indication that a tool is missing or that a particular job is overrunning. The system can also be programmed to disregard the absence of tools that have been removed deliberately for repair or replacement.

It may be noted that although the system checks for the presence of a tool in each of the sensed recesses, it does not check that the correct tool has been placed in each recess. In fact, since in the embodiment described above the detectors are simple magnetic detectors, it would be relatively easy to mislead the detection system, for example by placing a steel bolt in one of the recesses instead of the correct tool. This is not considered to be a serious disadvantage, since the main aim of the system is to ensure that trusted personnel do not accidentally forget to return tools to the container after use, rather than preventing deliberate theft. However, it is worth noting that since the system also records who has taken each tool from the container, this will deter deliberate theft, particularly if regular visual inspections of the cabinet are also carried out.

If necessary, the system can be adapted to include more sophisticated sensors that are capable of detecting the presence of individual tools such as optical sensors or mechanical switches may be used. Alternatively, instead of providing a separate sensor for each recess, the cabinet may include an array of optical sensors mounted above each drawer, which scan the drawer as it is opened, in a manner similar to a conventional optical scanner. An image of the drawer can then be generated, which can be compared with previous images to sense the removal of tools from the recesses or their replacement in the recesses. Alternatively, instead of optical sensors, an array of magnetic sensors can be used to scan the drawer as it is opened. Another alternative is to use a camera system with image recognition means arranged to detect the shape of the tools or optical character recognition means arranged to read codes etched onto the tools. Another option is to apply barcodes to the tools and use barcode reading devices to detect the presence of the tools.

It will be appreciated by the skilled person the computing device 13 can include some or all of the processing functions of the remote computer system 26 so that the tool cabinet 2 can be a stand alone unit. The data connection 16 is optional in this case. Alternatively, some or all of the data processing can be undertaken by the remote computer system 26. In this case, it may not be necessary to have a separate computer device 13 within the cabinet 2.

The tool cabinet 2 can be of any suitable design and may not include drawers 6 but rather may have one or more storage compartments that are accessible by one or more doors. The micro-switches 8 can determine whether or not the doors are closed.

The invention is not strictly limited to tool cabinets but is also applicable to cupboards, storage containers, storage rooms and the like. Also, certain embodiments can be used in relation to trays or other tool storage locations that are not enclosed, for example some workstations in factories have trays of tools without any additional casing. These trays can be replaced with modified trays similar to the drawer liners 7, which have a recess for each of tool, a sensor 12 associated with each recess and a data processing device similar to the computer device 13 and/or computer system 26. Similarly, various aspects can be applied to gun racks for military applications, wherein a sensor 12 is positioned adjacent each gun receiving location on the gun rack, each sensor 12 is connected to a data processing device similar to the computer device 13 and/or computer system 26.

Instead of using micro-switches, other means can be used for detecting whether a cabinet drawer or door is open, for example sensor such as magnetic or optical sensors.

The tools may also of course be of any kind, including engineering tools, surgical tools and so on. Some embodiments may also be adapted to other non-tool applications where an inventory control system is required, and references within this specification to tools should be construed accordingly to include equivalent items in suitable non-tool applications. Certain embodiments, may for example be used for inventory taking or stock taking/control purposes.

A plurality of tool cabinets 2 can be connected to the remote computer system 26. Thus the remote computer system 26 can be arranged to monitor and record the removal and replacement of tools from a network of tool cabinets within, for example a manufacturing facility. Via the network connection 38, the computer system 26 can monitor and record the removal and replacement of tools of tool cabinet at other manufacturing sites. For example, a large manufacturing company may have several manufacturing facilities located in different countries and the network connection 38 can allow a central facility to receive data from multiple sites to monitor tool usage. This data can be used in conjunction with job schedule information to compare the productivity of different facilities.

Instead of using RFID tags 31 the system can use RuBee tags together with a plurality of RuBee tag base stations. RuBee tags operate on the IEEE P1902.1 protocol and use long wave magnetic signals, typically around 131 kHz. RuBee tags operate differently from RFID tags 31, they are essentially networked transceivers that transmit a data signal, whereas RFID tags operate on a backscatter principle. RuBee tags are bidirectional, on-demand and peer to peer. RuBee tags are particularly useful in situations in which either end (or both ends) are near steel, which is frequently the case for tools, since the waves are not affected by steel or people. Also, they tend to have longer battery life than RFID tags.

The RuBee base stations can similarly be used to determine the position of the RuBee tag via triangulation.

RuBee tags differ from RFID tags in that nearly all the energy radiated by a RuBee base station or tag is contained in the magnetic field (H) and not the Electric field (E). This is because their antennas are relatively short when compared to the wavelength. Also, RuBee is a packet based protocol in which only one end of the communication at a time generates fields.

It will be apparent to the skilled person that other known location techniques can be used, for example the positioning system can be a Real Time Location System (RTLS) using a plurality of transmitter-receiver devices that are arranged to detect a device by trilateration, Angle of Arrival (AoA), Line of Sight (LoS), Time of Arrival (ToA), Time Difference of Arrival (TDoA), Received Channel Power Indicator (RCPI), Received Signal Strength Indication (RSSI), Time of Flight (ToF) and may include directional antennae. For outdoor applications a GPS type system can be used.

Optionally, instead of the detectable tag 31 being incorporated in the identification tag 29, it may comprise a stand alone device that can be carried by the user. For example, the cabinet 2 may include recesses 10 for receiving RFID tagged devices that can be removed from the cabinet 2 when the user removes the tools. The computer system 26 can be arranged to track the position of the RFID tag 31 when the tagged device has been removed from the cabinet 2 and stop tracking when the device is replaced.

If the access system uses an RFID or RuBee tag type access control system then the RFID or RuBee access control tokens can be used for location purposes by the positioning system.

While the above detailed description has shown, described, and pointed out novel features as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. An inventory control system, comprising:
a plurality of inventory item storage locations; and
an access system for controlling access to the inventory items, said access system, comprising:
an input device for entering the identity of a user;
a monitoring system configured to monitor the removal and replacement of the inventory items from the storage locations;
at least one locatable device configured to be removed by a user of the inventory control system;
a positioning system configured to locate the locatable device; and
a data processing system configured to record the removal and replacement of inventory items, the identity of the user of the inventory items and location data received from the positioning system such that the movement of the locatable device is tracked.

2. The inventory control system according to claim 1, wherein the positioning system includes a real time location system having a plurality of transmitter-receiver devices arranged to locate the position of the locatable device.

3. The inventory control system according to claim 2, wherein the locatable device includes a RFID tag and the positioning system includes a plurality of RFID tag detecting devices.

4. The inventory control system according to claim 2, wherein the locatable device includes an RuBee tag and the positioning system includes a plurality of RuBee tag detecting devices.

5. The inventory control system according to claim 1, wherein the positioning system is arranged to locate the locatable device by triangulation or trilateration.

6. The inventory control system according to claim 1, wherein the monitoring system comprises at least one of a sensor system, a camera system with image recognition, a camera system with optical character recognition, and at least one barcode reading device.

7. The inventory control system according to claim 6, wherein the sensor system includes a plurality of sensors configured to sense the presence of inventory items in the storage locations, each sensor being associated with a storage location and arranged to generate a signal representing the presence or absence of an inventory item in the associated storage location.

8. The inventory control system according to claim 6, wherein the data processing system is constructed and arranged to identify the inventory items from the signals received from the monitoring system.

9. The inventory control system according to claim 1, wherein each inventory item storage location comprises an individually-shaped recess for receiving a specific inventory item, the shape of the recess being matched to the shape of the inventory item.

10. The inventory control system according to claim 1, further comprising an enclosure having a closure member that can be opened and closed by a user.

11. The inventory control system according to claim 10, wherein the enclosure comprises a container having a plurality of storage compartments,

12. The inventory control system according to claim 10, wherein the access control system includes a locking mechanism for controlling access to the inventory items in the enclosure.

13. The inventory control system according to claim 1, wherein the access control system includes at least one user identification device to enable a user to log in via the input device.

14. The inventory control system according to claim 13, wherein each user identification comprises at least one of: a swipe card, a chip and pin card, an RFID tag, a RuBee tag, and a proximity device, and wherein the input device comprises a reading device compatible with the user identification.

15. The inventory control system according to claim 14, wherein the locatable device and the identification device are integrated into a single unit.

16. The inventory control system according to claim 1, further comprising storage locations for receiving the locatable device.

17. The inventory control system according to claim 16, wherein the monitoring system is arranged to monitor the removal and replacement of the locatable device.

18. The inventory control system according to claim 16, wherein the data processing system is arranged to start tracking the movement of the locatable device in response to receiving signals from the monitoring system that the locatable device has been removed from its storage location.

19. The inventory control system according to claim 18, wherein the data processing system is arranged to stop tracking the movement of the locatable device in response to receiving signals from the monitoring system indicating that the locatable device has been returned to its storage location.

20. The inventory control system according to claim 1, wherein the data processing system is arranged to start tracking the movement of the locatable device in response to receiving signals from the access system indicating that the user has logged in.

21. The inventory control system according to claim 1, wherein the data processing system is arranged to start tracking the movement of the locatable device in response to receiving signals from the monitoring system indicating that the user has removed inventory items from the storage locations.

22. The inventory control system according to claim 1, wherein the data processing system is arranged to stop tracking the movement of the locatable device in response to receiving signals from the monitoring system indicating that the user has replaced the inventory items in the storage locations.

23. The inventory control system according to claim 12, further comprising means for determining the operational status of the locking mechanism and means for inhibiting the operation of the monitoring system according to the signals received from the means for determining the operational status of the locking mechanism.

24. The inventory control system according to claim 12, wherein the locking mechanism is arranged to automatically open when an authorized user has been identified.

25. The inventory control system according to claim 1, wherein the data processing system is configured to record the time of removal and replacement of inventory items.

26. The inventory control system according to claim 10, wherein the data processing system is located remotely from the enclosure and is connected to the reading device by a data link.

27. The inventory control system according to claim 1, wherein the enclosure includes a local indicator device for indicating the presence and/or absence of inventory items in the enclosure.

28. A method of controlling inventory, the method comprising:
providing a plurality of inventory item storage locations;
operating an access system for controlling access to the inventory items, wherein operating the access system comprises:
with an input device, entering the identity of a user;
with a monitoring system, monitoring the removal and replacement of the inventory items from the storage locations;
with a positioning system, determining the location of at least one locatable device that is arranged to be removed by a user of the inventory control system; and
with a data processing system, recording the removal and replacement of inventory items, the identity of the user of the inventory items and location data received from the positioning system such that the movement of the or each locatable device is tracked.

29. The process according to claim 28, wherein the positioning system includes a plurality of transmitter-receiver devices.

30. The process according to claim 29, wherein the locatable device includes a RFID tag and the positioning system includes a plurality of RFID tag detecting devices.

31. The process according to claim 29, wherein the locatable device includes a RuBee tag and the positioning system includes a plurality of RuBee tag detecting devices.

32. The process according to claim 28, wherein the positioning system is arranged to locate the locatable device by triangulation or trilateration.

33. The process according to claim 28, further comprising an enclosure having a closure member that can be opened and closed by a user in order to gain access to the enclosure.

34. The process according to claim 33, wherein the container includes a plurality of storage compartments,

35. The process according to claim 32, wherein the access control system includes a locking mechanism for controlling access to the inventory items.

36. The process according to claim 28a, wherein the access control system includes at least one user identification device to enable users log into the access control system.

37. The process according to claim 36, wherein each user identification device comprises at least one of a swipe card, a chip and pin card, an RFID tag, a RuBee tag, and a proximity device, and wherein the input device comprises a reading device compatible with the user identification.

38. The process according to claim 37, wherein the locatable device and the identification device are integrated into a single unit.

39. The process according to claim 35, further comprising providing storage locations for receiving the locatable device.

40. The process according to claim 39, wherein the monitoring system is arranged to monitor the removal and replacement of the locatable device from the storage locations.

41. The process according to claim 38, further comprising starting to track the movement of the locatable device in response to receiving signals from the monitoring system that at least one of the locatable devices has been removed from its storage location.

42. The process according to claim 41, further comprising stopping the tracking of the movement of the locatable device in response to receiving signals from the monitoring system indicating that the locatable device has been returned to its storage location.

43. The process according to claim 35, further comprising starting to track the movement of the locatable device in response to receiving signals from the access system indicating that the user has logged in.

44. The process according to claim 35, further comprising starting to track the movement of the locatable device in response to receiving signals from the monitoring system indicating that the user has removed inventory items from the storage locations.

45. The process according to claim 44, further comprising stopping the tracking of the movement of the locatable device in response to receiving signals from the monitoring system indicating that the user has replaced the inventory items in the storage locations.

46. The process according to claim 28, wherein the inventory items are tools.

47. The process according to claim 28, further comprising reviewing the movement of the user in the event of an inventory item being lost.
